(19) United States
(12) Patent Application Publication
(10) Pub. No.: US 2012/0188699 A1
(43) Pub. Date: Jul. 26, 2012

(54) NOTEBOOK COMPUTER

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/053,305

(22) Filed: Mar. 22, 2011

(30) Foreign Application Priority Data
Jan. 24, 2011 (CN) 201110025758.7

(51) Int. Cl. G06F 1/16

(52) U.S. Cl. 361/679.26

(57) ABSTRACT

A notebook computer assembly includes a notebook computer and a supporting member. The notebook computer includes a base and a display pivotably attached to the base. The supporting member includes a first receiving portion and a second receiving portion for receiving the display and the base respectively, for stably supporting the notebook computer in an upright position.

### BACKGROUND

1. Technical Field

The disclosure relates to a notebook computer.

2. Description of Related Art

Although notebook computers may be considered convenient and small, when not in use, a notebook computer just takes up space when horizontally set on a desk.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a notebook computer assembly.

FIG. 2 is a side view of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

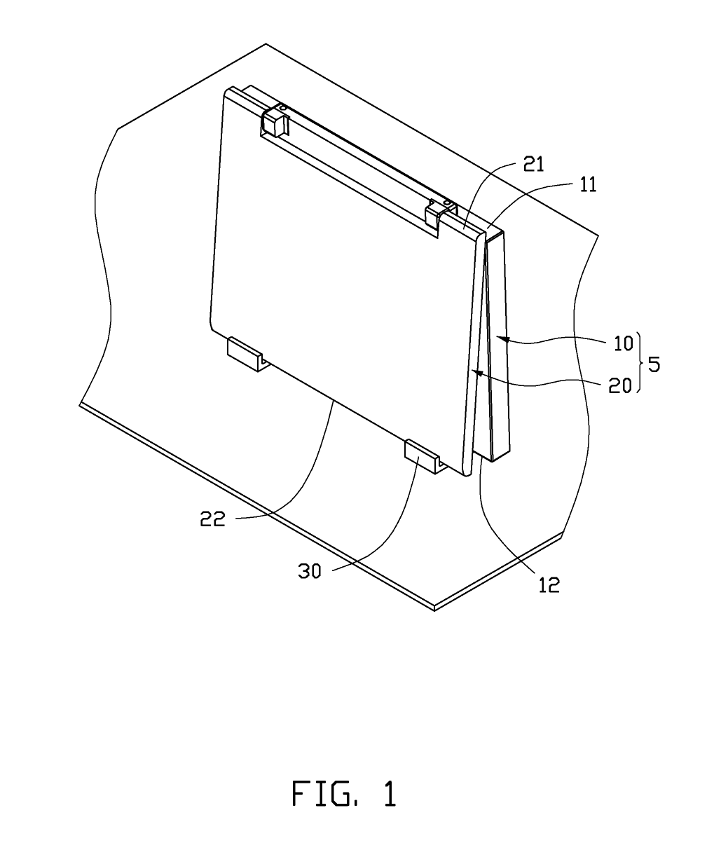

Referring to FIG. 1, an exemplary embodiment of a notebook computer assembly includes a notebook computer 5 and a supporting member 30. The notebook computer 5 includes a base 10 and a display 20 pivotably connected to the base 10 by hinges. The display 20 includes a first side 21, and a second side 22 opposite to the first side 21. The base 10 includes a first side 11 pivotably connected to the first side 21 of the display 20, and a second side 12 opposite and parallel to the first side 11.

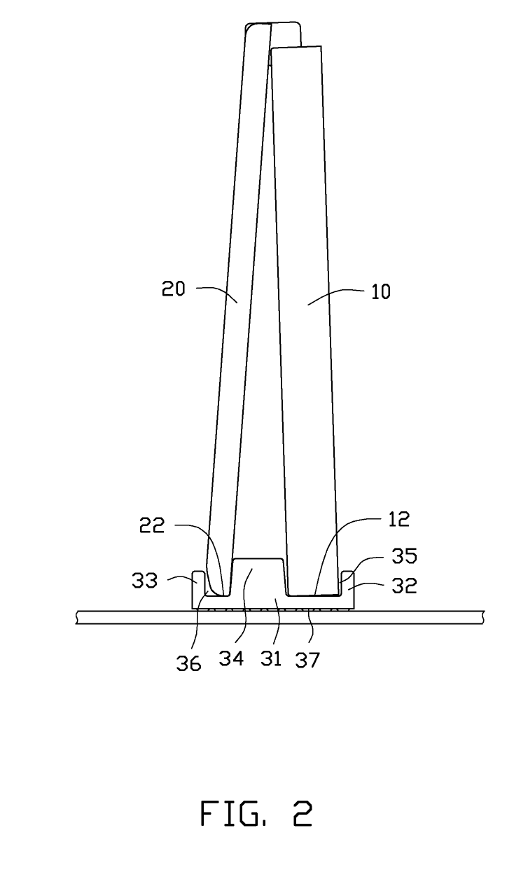

Also referring to FIG. 2, the supporting member 30 includes a bottom portion 31, and a first locating portion 32 and a second locating portion 33 extending up from opposite ends of a top surface of the bottom portion 31. A dividing portion 34 extends up from a middle portion of the top surface of the bottom portion 34, between the first locating portion 32 and the second locating portion 33. A first receiving space 35 is formed between the first locating portion 32 and the dividing portion 34. A second receiving space 36 is formed between the second locating portion 33 and the dividing portion 34. A plurality of skidproof pieces 37 extends down from a bottom surface of the bottom portion 31. The supporting member 30 can be made of rubber or plastic.

When the notebook computer is not in use, the supporting member 30 is set on a supporting surface, such as a desktop. The notebook computer 5 is pivoted to space the second side 12 of the base 10 from the second side 22 of the display 20. The second side 12 of the base 10 is positioned in the first receiving space 35. The second side 22 of the display 20 is positioned in the second receiving space 36. The skidproof pieces 37 can prevent the supporting member 30 sliding on the desktop.

In this disclosure, when the notebook computer 5 is not in use, the notebook computer 5 can be stored in an upright position on the desktop, which can save space.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A notebook computer assembly comprising:
a notebook computer comprising a base and a display, the base comprising a first side and a second side opposite to the first side, the display comprising a third side and a fourth side opposite to the third side, the third side of the display pivotably connected to the first side of the base; and
a supporting member comprising a first receiving space and a second receiving space spaced from the first receiving space, wherein the second side of the base is positioned in the first receiving space, and the fourth side of the display is positioned in the second receiving space.

2. The notebook computer assembly of claim 1, wherein the supporting member comprises a bottom portion, and a first locating portion and a second locating portion extending up from opposite ends of the bottom portion, a dividing portion extends up from a middle portion of the bottom portion, between the first locating portion and the second locating portion, the first receiving space is formed between the first locating portion and the dividing portion, the second receiving space is formed between the second locating portion and the dividing portion.

3. The notebook computer assembly of claim 2, wherein a plurality of skidproof pieces extends down from a bottom surface of the bottom portion.

4. The notebook computer assembly of claim 1, wherein the supporting member is made of rubber or plastic.
